(19) United States
(12) Patent Application Publication
(10) Pub. No.: US 2006/0041375 A1
(43) Pub. Date: Feb. 23, 2006

(54) Automated georeferencing of digitized map images

(75) Inventors: Alan Witmer, Lebanon, NH (US); James Hagan, Grahtham, NH (US); Brian Scaffidi, Grafton, NH (US); Jon Hancock, Lebanon, NH (US)

Correspondence Address: NIXON PEABODY, LLP, 401 9TH STREET, NW, SUITE 900, WASHINGTON, DC, 20004-2128, US

(73) Assignee: Geographic Data Technology, Inc., Lebanon, NH (US)

(21) Appl. No.: 10/921,260

(22) Filed: Aug. 19, 2004

(51) Int. Cl. G01C 21/30

(52) U.S. Cl. 701/208; 340/995.1

(57) ABSTRACT

A system and method for automatically georeferencing digitized images selects and analyzes image landmark points from disparate sources for image co-registration. A composite alignment of raster images and geographic target vectors is automatically generated using metadata sources for use in geographic display and editing environments. Cartographic alignment of raster images to geographic vector data sets is performed to co-position image data with geographic vector data sets. The co-registration and display permits a meaningful overlay of the data sets and an improved comparison of vector data to the correctly-registered images based on the physical relationships between the vector data and the underlying image features. By incorporating metadata regarding landmarks and other points of interest, users may query target vectors to display attributes of the associated landmarks and create a highly accurate parcel map for validating image information in areas where the data was acquired in sub-optimal conditions.

### BACKGROUND OF THE INVENTION

1. Technical Field of the Invention

The present invention is directed to a system and method for analyzing geographic features and landmarks such as those used in the generation of maps, atlases, online maps, and navigational systems. In particular, the present invention is directed to a system and method of automatically generating a composite alignment of raster images and geographic target vectors for use in geographic display and editing environments.

2. Description of Related Art

Many businesses compile geospatial information and maintain geospatial information systems. The geospatial information is gathered from multiple, disparate sources and used to build a unified, coherent database from which geospatial images may be produced. Geospatial information providers acquire the geospatial data and sell the data to a variety of customers that require the information to operate their businesses. For example, geospatial information may be utilized by mapping agencies, delivery companies, and map service providers that offer location information, direction information, and routing information to end users. Different users require different map information, and similar locations may be accurately described by innumerable maps, including those illustrating streets, topography, hydrology, elevation and relief information, political boundaries, and the like. In many cases, users require an amalgam of information that may appear on separate, discrete maps. Often information found in other sources such as in lists and in a variety of printed matter must be illustrated graphically to show relationships to locations. The combination of disparate data with map data often provides the most accurate and readily-understood method with which to evaluate and understand materials presented and relationships illustrated.

For example, an overlay of two data sources provides a convenient comparison when one data source is known to be accurate and the other data source is under evaluation. Comparing the data from the second source to the known-accurate first source allows for correction of the second source based on the obvious physical relationships between the features of the second source and the features visible on the underlying, accurate first source.

Additionally, with map data used for navigation, a user may select a road in a map image, and a composite aligned display constructed by the present invention can query map vectors to display attributes such as street name, street width, lane count, or usage restrictions. Similarly, selecting a parcel or a building on an image may return information such as an actual address, occupancy information, and other attributes.

Georeferencing repositions an image, or data regarding the image, with another image or data source to generate a composite image, which may comprise one or more images with data from each of the singular sources. Points defining the same landmarks are mathematically correlated in the composite image to produce an overlay effect where features of each of the singular data sources may be identified in the composite image. To generate an accurate mathematical correlation formula that places the map features in the correct geometric space requires accurate selection of at least three non-colinear landmarks in both data sources and transforming the landmarks to align the image. In conventional systems, this cartographic alignment is often performed manually by analysts and mapping technicians, requiring considerable operator attention to process the images. The alignment process requires significantly greater resources when the images are rotated or when common landmarks between the two data sources are difficult to discern.

One example of a method of associating features of two geographic databases is shown in U.S. Pat. No. 6,636,804 issued to Joshi. The '804 patent includes a method of building a proximity matrix with a proximity value element for each common feature of the two databases. A singular value decomposition of the proximity matrix is then computed, and the results are converted into an association matrix by executing an exclusion routine. The method identifies an associated feature pair by using the association matrix and an accuracy metric to evaluate how closely the representation of the geographic feature matches the actual geographic feature. However, the system and method of the '804 patent does not determine the accuracy of the geographic images using metadata prior to associating the first feature with the second feature. The accuracy is determined only after merging the features of the geographic database images. Additionally, the '804 patent does not provide a means to deal with to image information; instead, landmarks (features) must first be created or extracted in some way before the technique may be used.

In another example, U.S. Pat. No. 6,366,851 issued to Chojnacki et al. discloses a method and system for automatic centerline adjustment of shape point data for a geographic database. Data representing positions along roads are acquired using Global Position System (GPS) equipment installed in a vehicle that is driven on the roads. The raw data is processed and adjusted by comparing the raw data to data from a second GPS sensor. The data is fused and smoothed by using a least-squares fit to a cubic equation or other smoothing equation using other data filters. The smoothed data is then scrubbed of outlying data points and then used to determine the centerline of the street under evaluation. The '851 patent uses vector-based data only and provides no means for dealing with raster images. Additionally, the '851 patent does not make use of centroid determination to accurately generate map representation vectors for use in conflating map representation vectors and target vectors in arriving at an accurate composite image.

In yet another example, U.S. Pat. No. 4,984,279 issued to Kidney et al. discloses a method of integrating satellite images with representational data, including text information. The '279 patent reproduces and manipulates satellite image data to produce a smooth and uniform representation of land areas from a number of individual image data records by comparing elements of image data with elements of feature data and replacing the image data element to incorporate textual material defined by the element of text data. However, the '279 patent provides only a one-way correction based upon the feature data composition. The feature data is assumed to be correct and may not be altered by the image data. Also, the '279 patent provides no positional correction to either image, nor does it rely upon automated methods for generating image metadata.

Geospatial business information for any given geographical area is frequently subject to change and often may be inaccurate. New streets are constructed, intersections are moved, tracts of new houses and streets to reach housing developments are built. Geospatial information providers deliver a better product to their customers when they seek new information and refine their existing store of information to update and correct it.

Presently, most changes to the geospatial information of geospatial information providers are provided in an ad hoc manner. Customers may request changes to the geospatial information by submitting e-mails, telephone calls, or mailed paper maps that describe changes to be made to the geospatial information. These changes may include modifications to street names or the additions of new streets. However, maintenance of millions of street information records using such an ad hoc updating method is extremely inefficient and cannot be sustained without expending a tremendous amount of resources both by the submitting party and by the georeferencing party.

In addition, such a method of updating geospatial information is often impossible since the materials provided by the requesting customer may not be complete and may fail to specifically identify the location for which the changes to the geospatial information record should be made. For example, the correspondence from the customer may identify changes for a street in a county which is identified by name, but multiple counties with the same name may exist in numerous different states in the United States. Additionally, multiple roads with the same name may exist within the same county.

Another method of updating geospatial information is to use pre-registered satellite or aerial imagery. This imagery can be used “out of the box” with a geographic database because providers often incorporate geographic registration with the product. Unfortunately, such imagery is limited in geographic area and in currency-many areas of lower-density population are ignored by high-resolution imagery providers. Furthermore, inclement weather at the time of recording may lead to spotty coverage overall. Aerial photography also has the impediment that it includes no identifying information about the features represented; roads are not shown with names, invisible boundaries such as parcels are not perceptible, and parcel numbers or house addresses are not readily identified by the scenery.

As a consequence of these various limitations of the conventional manners of updating geospatial information, requested changes may take many months to implement. During this time, the requesting customers would not be aware of whether the changes have been approved or the status of the requested update.

What is needed is a new type of system and method for automatically georeferencing map images while improving the quality of the mapping information. The most accurate information available must be used to update and correct existing maps and to generate new map images.

### SUMMARY OF THE INVENTION

The present invention relates to a system and method for analyzing geographic features and landmarks such as those used in the generation of maps, atlases, online maps, and navigational systems. In particular, the present invention is directed to a system and method of automatically generating a composite alignment of raster images and geographic target vectors by applying metadata sources for use in geographic display and editing environments.

The present invention provides an elegant, simple, and powerful manner of performing an automated georeferencing process. The present invention advantageously includes a platform-independent, server-side software package that allows users to accurately create and edit georeferenced images using a geographic database, a metadata source, and a repository of raster image data.

The present invention cartographically aligns raster images to geographic vector data sets so that the images may be co-positioned with the geographic vector data sets for use in geographic display and editing environments. The co-registration and display permits a meaningful overlay of the data sets. With this accurate overlay, a comparison of vector data to the correctly-registered images permits improvement and updating of the vector data based on the physical relationships between the vector data and the features visible in the underlying images. Additionally, by incorporating metadata regarding landmarks and other points of interest along roadways or other routes, the system of the present invention can query target vectors to display attributes such as the name, width, lane count, and usage restrictions of a particular route. Similarly, selecting a parcel or a building on an image may return information such as an actual address, business name, occupancy information, and other attributes. Further, by incorporating metadata with the geographic target vector data set, the automated georeferencing of the present invention can create a highly accurate parcel map, which may be useful for validating or clarifying image information in areas where the imagery data was acquired in sub-optimal conditions, such as under atmospheric noise, or cloud or vegetation cover.

The system of the present invention provides an automated georeferencing process by determining a map centroid based on metadata corresponding to geographic image data. The map centroid is then used with raster map data to extract map representation vectors by using a variety of features, scale marks, and orientation information from the raster map data along with the determined centroid. The extracted map representation vectors are then conflated against the geographic image data to build positional correspondences based on a variety of match criteria. The matched positional correspondences are then stored as warped and co-registered images in a georeferenced image repository. The stored images may then be presented to a user on a computer system or other display.

### BRIEF DESCRIPTION OF THE DRAWINGS

The features mentioned above and additional benefits of this invention and the manner of attaining them will become more apparent from the following detailed description of the preferred embodiments of the present invention when viewed in conjunction with the accompanying drawings.

FIG. 1A is a schematic illustration of an automated georeferencing system in accordance with the present invention.

FIG. 1B is a schematic illustration of an automated georeferencing system in accordance with the present invention implemented in a client-server environment.

FIG. 2 is an overall process flow diagram showing high level steps used to perform a method of producing automated georeferenced images in accordance with the present invention.

FIG. 3 is a process flow diagram showing steps to determine a map centroid performed by an automated georeferenced system in accordance with the present invention.

FIG. 4 is a process flow diagram showing steps to extract features for georeference control performed by an automated georeferenced system in accordance with the present invention.

FIG. 5 is a process flow diagram showing steps to define matches between map representation vectors and target vectors in accordance with the present invention.

FIG. 6 is a process flow diagram showing steps to generate and display warped and co-registered images performed by an automated georeferenced system in accordance with the present invention.

FIG. 7 is an example of a mapped region comprised of multiple map sheets generated according to the method of the present invention.

FIG. 8 is an example of a parcel map showing parcels and blocks for use in accordance with the method of the present invention.

FIG. 9 is an example of geographic information stored in the geographic database in the form of target vectors for use in accordance with the present invention.

FIG. 10 illustrates extraction of a rasterized parcel map and the north arrow parsing to determine the rasterized map in accordance with the present invention.

FIG. 11 illustrates scale inference of an extracted rasterized parcel map in accordance with the present invention.

FIG. 12 is an example of determined map representation vectors for street centerlines in accordance with the present invention.

FIG. 13 illustrates map representation vectors after a raster centerline was converted using the centroid determined in accordance with the present invention.

FIG. 14 illustrates conflation correspondences between map representation vectors of the parcel map and target vectors from the geographic image repository.

FIG. 15 illustrates the completed georeferenced results after completion of the method of the present invention.

### DETAILED DESCRIPTION OF THE INVENTION

The invention is described in detail with particular reference to certain preferred embodiments, but with the spirit and scope of the invention, the invention is not limited to such embodiments. Those of skill in the art will appreciate that various features, variations, and modifications can be included or excluded, with the limits defined by the claims and the requirements of a particular use.

The present invention extends the functionality of current georeferencing systems by allowing users to automatically generate co-position alignment of geographic target vectors and raster map image data with exceptional accuracy by determining the centroid of the raster map area of coverage prior to extracting information from the raster map data. The present system has many advantages over prior systems such as those requiring extensive operator interaction, because the accurate automated generation of co-registered data permits quick and affordable control of the validation and updating of accurate geographic data.

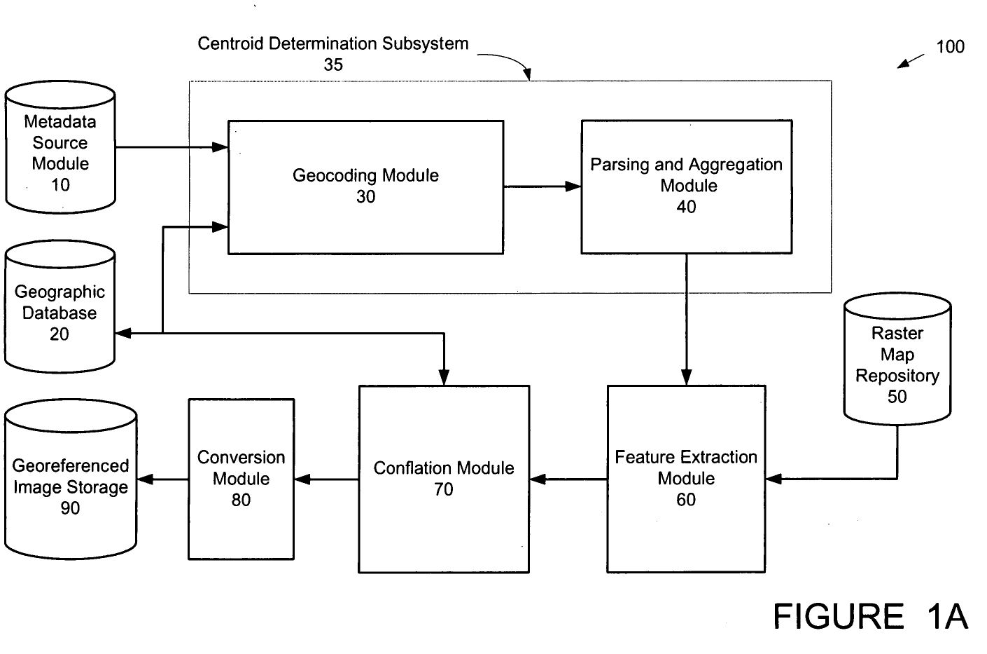

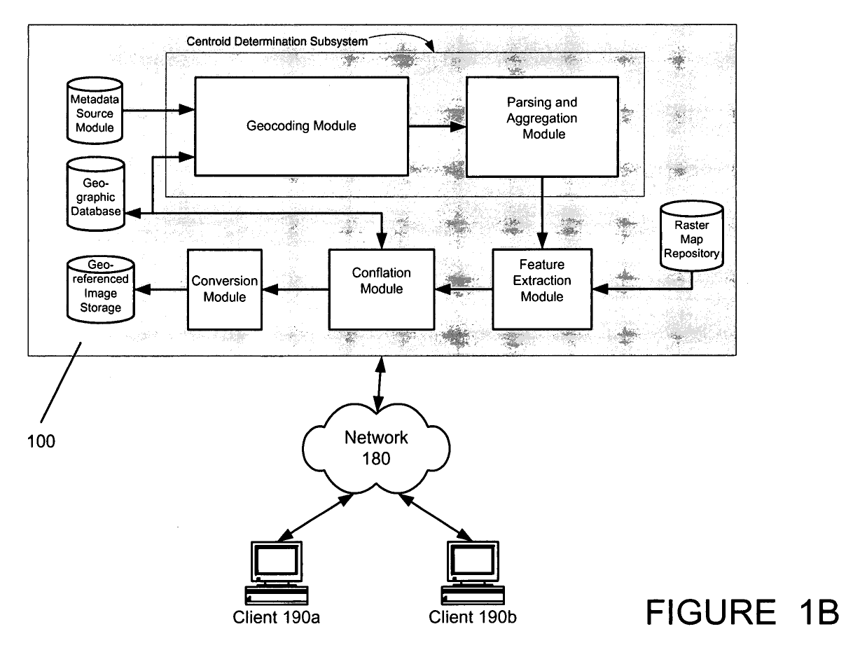

As shown in FIG. 1A, an exemplary embodiment of the system 100 of the invention includes a metadata source module 10, a geographic database 20, a geocoding module 30, a parsing and aggregation module 40, a raster map repository 50, a feature extraction module 60, a conflation module 70, a conversion module 80, and a georeferenced image repository 90.

The system of the present invention may be implemented in a client-server environment such as that depicted in FIG. 1B, where a server and associated peripheral devices are used to house the system 100 and a number of clients 190a, 190b may be used to access the information provided by the server through network 180. For convenience and brevity, in FIG. 1B two exemplary clients 190a, 190b are shown, but an unlimited number of clients may be associated with each server.

As shown again in FIG. 1A, system 100 is comprised of modules that perform specific operations to carry out a method of automated georeferencing of map images in accordance with the present invention. The modules may be software sub-routines or program files called to perform specific operations to carry out the method of the present invention. It should be understood that these modules and units are merely schematically illustrated based on their function for clarity purposes, and do not necessarily represent specific hardware or software. In this regard, these modules, units and other components may be hardware and/or software implemented to substantially perform their particular functions explained herein. The various functions of the different components can be combined or segregated as hardware and/or software modules in any manner, and can be useful separately or in combination. While software modules are shown, all or a portion of the exemplary embodiments can also be conveniently implemented by the preparation of application-specific integrated circuits or by interconnecting an appropriate network of component circuits. Thus, the present invention as schematically embodied in FIG. 1A should not be construed to limit the automated georeferencing system 100 of the present invention, but be understood to merely be a schematic example. For simplicity and brevity, an exemplary embodiment utilizing software modules is shown in FIG. 1A.

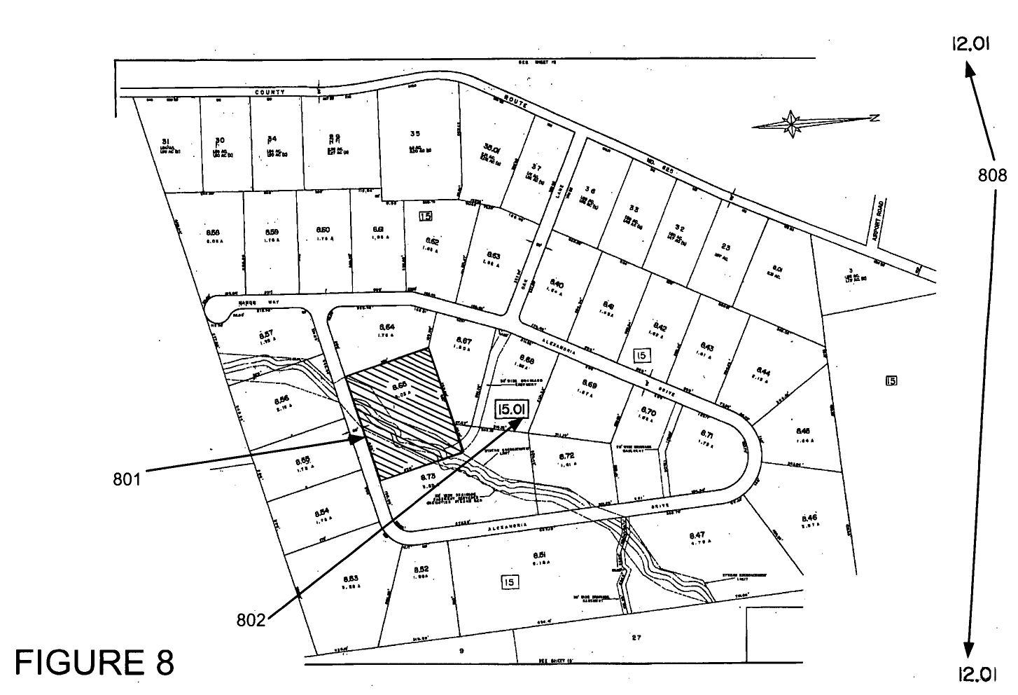

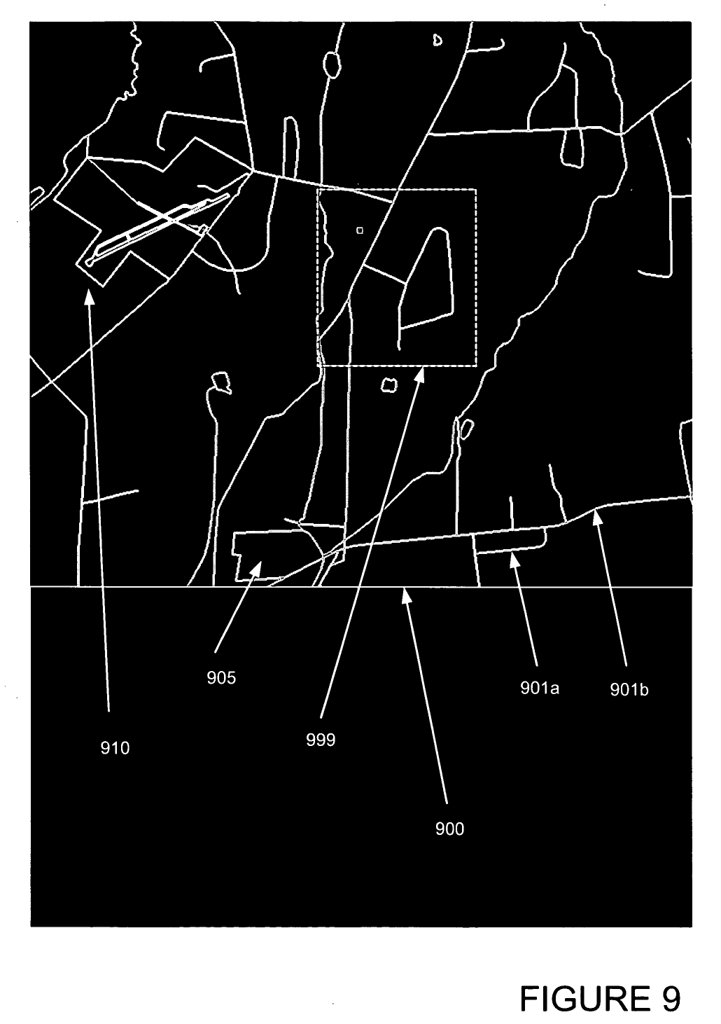

In FIG. 1A, an exemplary embodiment of the present invention utilizes system 100 to create an accurate, updated overlay of two or more maps. The overlay may be created by simultaneously mapping two different types of data or combining (i.e., co-registering) different data types, for example a parcel map (as shown in FIG. 8) and a street map (as shown in FIG. 9). As shown in an exemplary embodiment of the present invention, the overlay may also be an update of two existing maps combined with new data from a third source. The third source may include new information that was previously not incorporated on the two existing maps. For example, a third source may be updated metadata regarding an existing parcel map. In any event, when new information is acquired, be it new metadata, a new parcel map, or a new street map, the new information may be added to an existing map by the present invention to create an accurate new map.

As shown in system 100 of FIG. 1, metadata source module 10 is a repository for metadata corresponding to geographic data. Metadata source module 10 may contain master address lists, assessment information, or any additional data that provides information about the quality, currentness, consistency, and appropriate usage of geographical datasets. The metadata source module 10 may contain metadata conforming to the Federal Geographical Data Committee Standards, but also may be in the format of a generic comma-delimited text record file. In an exemplary embodiment of the present invention, a comma-delimited text record file is utilized, which contains a master address list of block and parcel information regarding a particular locale. The block and parcel information used in an exemplary embodiment of the present invention corresponds to traditional census and tax assessment information where a block may be thought of as the area that can be formed by intersecting visible features, such as streets. The classic block is the rectangular city block bounded by four streets. A block is made up of a number of adjoining parcels. An example of a parcel map is shown in FIG. 8 and is representative of a rasterized map stored in the raster map repository. Each of the approximately rectangular land areas, such as those areas labeled 8.55, 8.54, and 8.65 are parcels. Parcel number 8.65 is shaded and shown as reference numeral 801 to illustrate a single parcel. This parcel 801 is one of nine parcels that comprise block 15.01, labeled in FIG. 8 with reference numeral 802. The block identifier and parcel identifier for this particular land area would then be 15.01, 8.65, respectively. A map itself may be labeled with a particular map number 808 to provide a recognized manner of identifying the particular map and particular types of maps. In the example illustrated in FIG. 8, the parcel map is also identified by its map number (12.01) as shown by reference numeral 808. Maps, such as parcel maps, that are created by quasi-authoritative entities or widely used by the public-at-large may be referenced by their map number. For example, when one user indicates to another user that the map at issue is map number 12.01 from Alexandria Township in Santa Ana, Calif., both users will understand that map at issue to be the map illustrated in FIG. 8. In this manner, a particular land area or landmark may be accurately identified by a record in a database or data file or other means for storing information and be readily located on a map or in an atlas of maps.

Metadata source module 10 may also contain positions from a physical index page from a book, electronic reference coordinate information, parcel map information such as cross-referenced parcel and block codes with address points, or any set of address points that match a map's coverage. Alternatively, address points may even have been derived mathematically by decoding a map numbering scheme, should one exist. This information is often sufficient to enable an alternative embodiment in which the centroid determination subsystem 35 may be augmented or even replaced, with address points then passing directly to the feature extraction module 60. Metadata records may extend beyond a particular street map or parcel map's boundaries and encompass many adjoining maps. For example, tax assessment metadata records may list all properties in an entire county, while a particular street map may be limited to only several blocks. The metadata source module 10 may be a database, or other means by which metadata records may be stored and accessed.

In an exemplary embodiment, the metadata is a master address list comprising a file of comma-delimited text records. Each master address list text record may include block and parcel identification numbers, an address, a tax assessment, and other information describing the locale. The metadata source may be a database record with any number of data fields.

Geographic database 20 includes location information for any number of locales and places. Maps represent one form of location information. The location information is stored in geographic database 20 as target vectors. Target vectors contain attribute data attached to a mathematical representation, such as a curve, a line, an oval, a solid, a face, and the like. Attribute data may comprise street map inputs, soil data, topology, parcel and block identifiers, and any number of additional fields related to physical, environmental, and other characteristics of the locales and places. The target vectors may be stored in a conventional database or in other suitable data storage means adapted to store and provide access to geographic information.

In an exemplary embodiment, the target vectors from the geographic database 20 and the comma-delimited text file from the metadata source module 10 are passed to the centroid determination subsystem 35. The centroid determination subsystem 35 comprises geocoding module 30 and parsing and aggregation module 40.

As described above, target vectors from the geographic database 20 may be generally described as mathematical representations, such as lines from a map, combined with additional attribute information that accompanies the lines. Some of the lines may be straight denoting a long expanse of roadway, while others may be curves or ovals that might denote a court or a circle in a particular housing development. Additionally, other landmarks may be shown such as businesses or other non-thoroughfares. A basic target vector may simply contain latitude and longitude information as well as attribute information. In each case, the target vectors represent distinct features on a physical map with additional information (attribute information) related to each distinct feature.

The comma-delimited text file from the metadata source module 10, on the other hand, may simply be a string of records from a database file. In a preferred embodiment of the present invention, the latitude, longitude, parcel identifiers, block identifiers, and other information comprise the file of comma-delimited text records from the metadata source module 10. The information is contained in a file format rather than as distinct features with accompanying attributes.

In an exemplary embodiment, the metadata is information comprising a comma-delimited text record file such as the one shown below:

Master Address List

“008.65”,“0015.01”,“00101127”,“0012.01”,“001-011-27”,“S”,“”,
“0000002111”,“”,“W”,“000ALEXANDRIA”,“DR”,“”,“”,“SANTA
ANA”,“CA”,“92706”,“2300”,“C002”,“S00”,“”,“001-011-27”,“001-01”

Of course, other embodiments may contain target vectors and metadata in other formats more closely related to conventional “map data.”

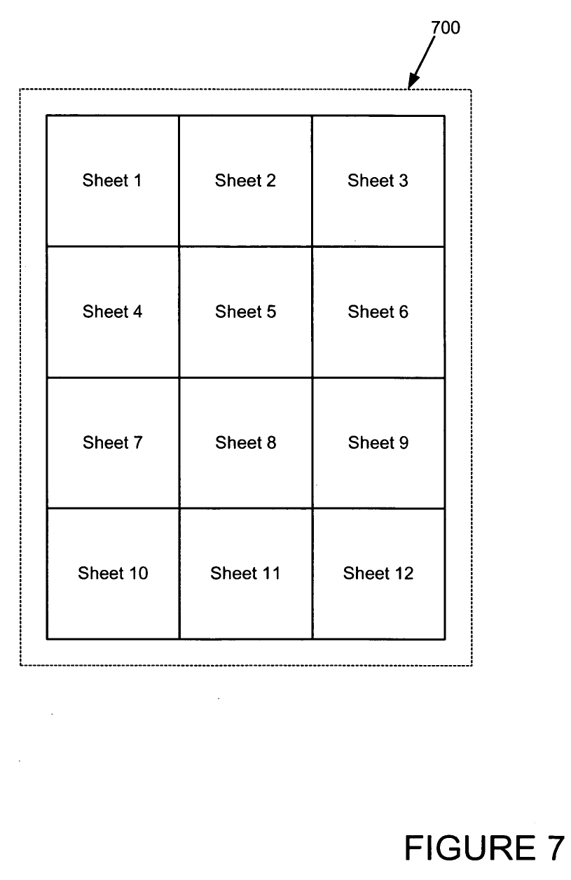

Centroid determination subsystem 35 uses the target vectors from the geographic database 20 and applies the comma-delimited text record file from the metadata source module 10 to determine a single center point (centroid) of an area of interest. Preferably, the area of interest is bounded by the geographic area described by the target vectors and by the geographic area described by the comma-delimited text record file. At times, however, the area of interest may extend beyond the boundaries described by the target vector or by the comma-delimited text record file, or by physical limitations placed on the appearance of the final overlay map. In this case, the area of interest may be divided into map sheets, where a number of map sheets are joined together to make up an area of interest. For example, FIG. 7 depicts an area of interest 700 comprised of map sheets 1 through 12.

If the area of interest extends beyond the geographic area described by the comma-delimited text record file from the metadata source module 10 or beyond the target vectors from the geographic database 20, multiple map sheets must be used to properly describe the area of interest. In this case of adjoining or disparate maps describing the area of interest, the centroid determination subsystem determines a single center point (centroid) for each map sheet.

To determine the centroid, geocoding module 30 builds a position index for each of the inputs from the metadata source module 10 and for each of the inputs from the geographic database 20. The geocoding module 30 creates each position index by associating each target vector of an area of interest from the geographic database 20 to corresponding metadata from the metadata source module 10. Each position index may be a record that is a superset of information from the target vector of the geographic database 20 and information from the comma-delimited text record file from metadata source module 10. Geocoding module 30 may be a proprietary module or consist of commercially-available geocoding modules as well.

Once the geocoding module 30 builds the position index records, geocoding module 30 passes the position index records to the parsing and aggregation module 40. Parsing and aggregation module 40 sorts the position indexes records and determines if the area of interest is larger than a single overlay map's boundaries (area of coverage). If the area of interest is larger than a single overlay map's area of coverage, the parsing and aggregation module 40 determines which position index records should appear on each overlay map sheet's area of coverage. The parsing and aggregation module 40 then determines a center point of each map sheet's area of coverage.

The determined center point (or center points) from the parsing and aggregation module 40 is then employed by the feature extraction module 60 in conjunction with inputs from a raster map repository 50 to determine map representation vectors. Additionally, if centroid information is available from other sources, the centroid information may be provided to the feature extraction module 60 as a discrete input. Regardless of the source of the centroid information, the map representation vectors are determined based on the feature extraction module 60 identifying and decoding directional information and scale information embedded in rasterized maps that are stored in raster map repository 50. In an exemplary embodiment, rasterized maps may contain digitized map images scanned and converted from paper maps or other non-digital media. The example of the block and parcel map of FIG. 8 is one such rasterized map. Feature extraction module 60 extracts directional information and scale information from the rasterized map and creates map representation vectors. Map representation vectors contain manipulated mathematical representations of landmarks from the rasterized image, such as curves, lines, ovals, solids, faces, and the like, represented in the same spatial environment as the target vectors from geographic database 20.

The extracted map representation vectors are then sent to the conflation module 70 where they are compared to target vectors from the geographic database 20. The conflation module 70 then matches the target vectors from geographic database 20 and the map representation vectors created in the feature extraction module 60.

The matched vectors are then used by the conversion module 80 to create warped and co-registered images. The images are then stored in a georeferenced image storage module 90 where they may be accessed, edited, and manipulated by users.

The automatic georeferencing of digitized map images contemplated by the present invention is used to properly update map data as new information is presented. New information may be in the form of new tax assessment records, which would replace the metadata records previously utilized in metadata source module 10. Additionally, new information in the form of new rasterized satellite images may be loaded into the raster map repository 50, and conflation with target vectors from geographic database 20 is required to properly align the new imagery. Further, updated information in geographic database 20 may be used to verify, confirm, and update conflated images. Regardless of the type of new information, by incorporating the process of the present invention, the georeferenced images are the most current and accurate representation of the area in question.

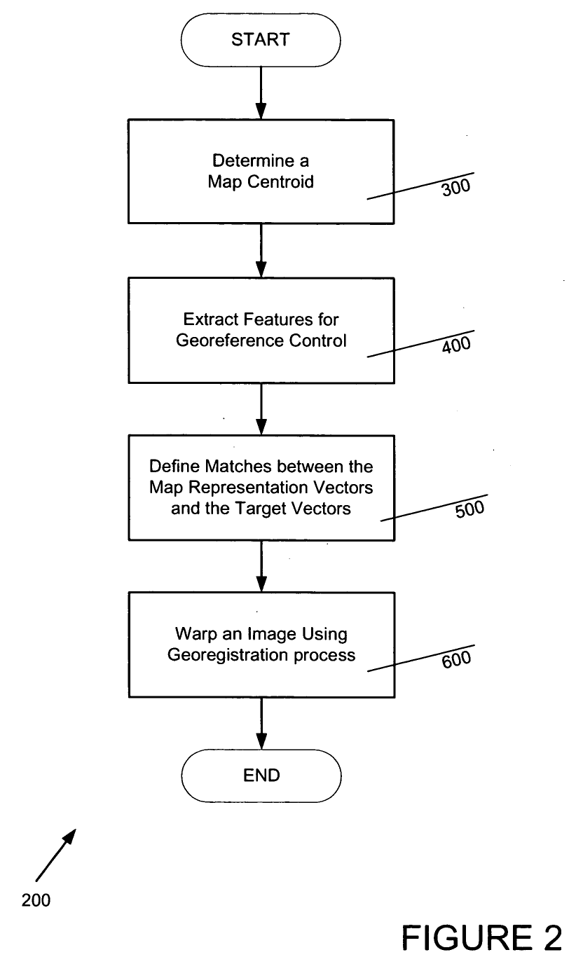

As shown in the flow diagram of FIG. 2, the automated georeferencing process used by the system modules of the present invention may be broken down into four sub-processes 200 for illustrative purposes. In step 300, the invention determines an appropriate map centroid from metadata records and geographic database target vectors. In step 400, the feature extraction module 60 extracts features including directional information and an inferred scale and determines the direction in which to apply the inferred scale, ultimately determining map representation vectors to be used in the conflation module 70. In step 500, the conflation module 70 defines matches between map representation vectors and target vectors, and in step 600, an image is warped and co-registered using a georegistration process, The image is then made available for display.

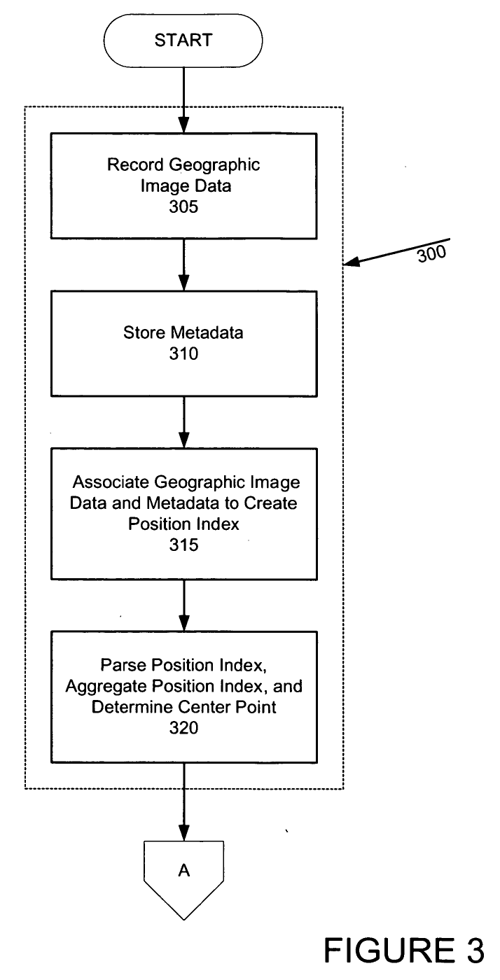

Referring now to FIG. 3, sub-process 300 begins by recording geographic image data in step 305. The geographic image data may already exist in a database or may be newly acquired or newly recorded data. As described above with regard to the geographic database 20, the geographic image data may include location information for any number of locales and places. Maps represent one form of location information. Location information may comprise street map inputs, street centerlines, soil data, hydrology, parcel and block identifiers, and any number of additional fields related to physical, environmental, and other characteristics of the locales and places. The location information is stored in geographic database 20 as target vectors. Target vectors contain attribute data attached to a mathematical representation, such as a curve, a line, an oval, a solid, a face, and the like. Attribute data may comprise street map inputs, soil data, topology, parcel and block identifiers, and any number of additional fields related to physical, environmental, and other characteristics of the locales and places. The target vectors may be stored in a conventional database or in other suitable data storage means adapted to store and provide access to geographic information.

In an exemplary embodiment, the target vectors comprise latitude and longitude information with regard to the locale. Of course, additional information regarding the locale may also be contained in the target vectors. Target vectors may be further described as data records regarding the locale that have at least a longitude field and a latitude field and one piece of attribute information. As outlined above, the target vectors may be stored in a conventional database or in other suitable data storage means adapted to store and provide access to the geographic information. The target vectors from the geographic database 20 are recorded for use in the geocoding module 30.

Referring to FIG. 9, an example of target vectors is shown as a street m ap 900 with a variety of landmarks, including streets 901a, 901b, parking areas 905, and an airport 910. Street map 900, and the target vectors that comprise the street map, is to be co-registered with a rasterized image (see the map of FIG. 8) to update and overlay the information represented by the disparate maps of FIG. 9 and FIG. 8. Since information regarding a particular locale is desired, both the disparate maps of FIG. 9 and FIG. 8 must represent the same geographic vicinity. Otherwise, co-registration and a meaningful overlay would be impossible. The dashed box 999 in FIG. 9 shows the approximate area covered by the rasterized image that comprises the parcel map of FIG. 8.

Returning to FIG. 3 and the method of the present invention, in step 310, metadata from metadata source module 10 is stored for use in the geocoding module 30. Metadata may comprise master address lists, assessments, and any additional data that provides information about the quality, currentness, consistency, and appropriate usage of geographical datasets. In a preferred embodiment of the present invention, metadata source module 10 contains metadata from a master address list that is a comma-delimited text record file with at least one data field that is common to the target vectors from the geographic database 20.

In an exemplary embodiment, the metadata is a master address list comprising a comma-delimited text record file such as the one shown below.

Master Address List

“008.65”,“0015.01”,“00101127”,“0012.01”,“001-011-27”,“S”,“”,
“0000002111”,“”, “W”,“000ALEXANDRIA”,“DR”,“”,“”,“SANTA
ANA”,“CA”,“92706”,“2300”,“C002”,“S00”,“”,“001-011-27”,“001-01”

The comma-delimited text record file above contains a parcel identification—008.65; a block identification—0015.01; a map number—0012.01; a street address—2111 W. Alexandria Dr.; a city and state-Santa Ana, Calif.; and a zip code field—92706. Additional data fields such as an assessor's identification number and others are also included.

In step 315, the geocoding module 30 builds each position index record using the master address list from the metadata source module 10 and the target vectors (geographic input data) from the geographic database 20. Geocoding module 30 builds each position index by taking each target vector from the geographic database 20 image data and associating each target vector with the corresponding master address list metadata from the metadata source module 10. The geocoding module 30 is, in essence, taking the two records from disparate sources and combining them to produce a position index record that is a combination of the individual data fields from each of the disparate records. Each position index record comprises the combination of information including longitude and latitude coordinates. Another important field culled from these records and associated between the two data sources is the parcel identification number and the block identification number, which are common attributes for sectioning locales and are used by tax authorities, real estate developers, and others who commonly have the need to determine accurate locations of landmarks and geographical boundaries.

Additionally, geocoding module 30 may perform a standardization process whereby similar street names or other data fields are standardized to a correct naming convention. For example, the geographic database 20 may list a particular street name with particular latitude and longitude coordinates as “Afton Lane” while the metadata source module 10 may list the same street in the master address list text record with the same latitude and longitude coordinates, but with the name, “Afton Ln.” The geocoding module 30 reconciles the two conflicting records and standardizes the street name based on a correct naming convention from a known-accurate source. More complex conflicts may also be resolved. For example, the geographic database 20 may list a particular street name with particular latitude and longitude coordinates as “Alton Hghts Ln” while the metadata source module 10 may list the same street in the master address list text record with the same latitude and longitude coordinates, but with the name, “Afton Ln.” The geocoding module 30 then reconciles the two conflicting records and standardizes the street name based on a correct naming convention from a known-accurate source. The known-accurate source may be a separate file or record, or may be a rule set up in the geocoding module 30 that indicates which record (target vector from the geographic database 20 or master address list from the metadata source module 10) is a known-accurate record. In this manner, the correct street name, “Afton Ln,” will be used throughout the remainder of the automated georeferencing process and “Alton Hghts Ln” will be discarded. Similarly, the geocoding module 30 may establish a naming convention or rule scenario for each of the data fields used to create the position index. Once each position index record is built, it may be stored as a flat text file.

Optionally, the geocoding module 30 may also perform error-correction routines whereby records from the metadata source module 10 and from the geographic database 20 that do not have at least one common field are identified, and an error message is generated indicating that no automatic association may be performed for those particular records. The errant records may then be manually corrected or interpolated using a variety of techniques including smoothing algorithms or other means of accurately estimating data fields in the records. Alternatively, the records may be discarded, and a less-than-complete set of records may be used to perform the remaining steps in the process of the present invention. Of course, the more complete the records, the more accurately the centroid may be determined, and the more accurately georeferenced images may be determined.

Referring again to FIG. 3, after the position index records are built and stored as flat text files, the flat text files are sent to the parsing and aggregation module 40 in step 320. Parsing and aggregation module 40 sorts the position index records by using a software script to parse the files into simple records containing the block identification number, the parcel identification number, and the position (longitude and latitude). The script utilizes information from the accessed metadata records by determining which position index records have a common assessor's number or a common map number or another common attribute field that was provided by the metadata record. In the master address list metadata record above, 12.01 is indicated as the map number in the metadata file.

In effect, the parsing and aggregation module 40 takes target vector data that was combined with metadata in the georeferencing module 30 to form position index records and organizes the position indexes based upon which position index records are likely to be illustrated on a particular map sheet. The parsing and aggregation module determines the likelihood that particular position indexes will appear on the same map sheet by evaluating position index records with the same map numbers (for example, map number 12.01 in the earlier example) or similar longitude and latitude values, or other identifying marks to categorize the position index records by geographic location.

In the example above, the metadata records describe features on a parcel map. Since each parcel map includes a group of blocks, at this point a many-to-one correspondence exists between position index records and each map sheet's area of coverage. The parsing and aggregation module 40 aggregates position index records that are likely to belong on the same map sheet. The area of interest (and its corresponding position index records) is divided by the parsing and aggregation module 40, and smaller map sheets are created that represent a distinct portion of the entire area of interest. An example of an area of interest comprised of multiple map sheets is shown in FIG. 7 where 700 is the area of interest and sheets 1 through 12 are separate map sheets. Since the map sheets tend to differentiate along tens or hundreds of blocks, it is typically sufficient to categorize position index records whose first n characters of the block identifier and parcel identifier are common. The parsing and aggregation module 40 then produces one record for each of these groups of categorized position index records, giving the average of the longitude and latitude points as the geographic location of the map sheet center point (the centroid). That is, parsing and aggregation module 40 takes the averages of the latitudes and the averages of the longitudes for a particular map sheet and determines this average to be the center point (centroid) of the particular map sheet.

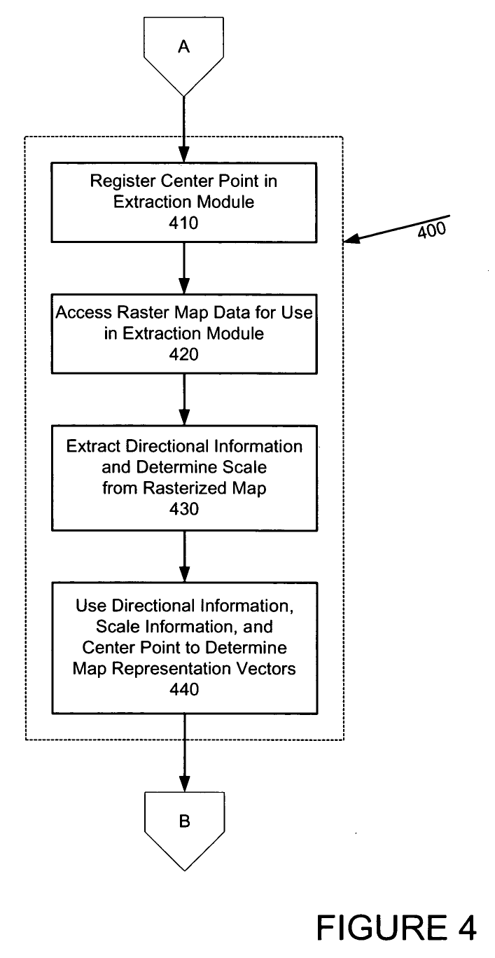

Once the centroid of each map sheet is determined by the parsing and aggregation module 40 in step 320, the centroid is registered in feature extraction module 60 at step 410 of FIG. 4. This determined center point is then used by the feature extraction module 60 in conjunction with inputs (e.g., a rasterized parcel map) from a raster map repository 50 to determine map representation vectors. Raster map repository 50 may be included in the system 100 of the present invention, or alternatively, raster map repository 50 may be housed and maintained by an outside source. Raster map data, such as scanned or digitized maps, may be provided by an outside source providing access to a raster map repository 50 through subscription or licensing services. In any case, raster map data is accessed in step 420.

In step 430, the feature extraction module 60 extracts rasterized image features as vectors that can be later used to correlate the rasterized map's scene with the target vectors from the geographic database 20. These rasterized image features are mathematical representations of landmarks and include lines, curves, and the like. These map representation vectors are determined by the feature extraction module 60 identifying and decoding directional information embedded in the rasterized map, determining the proper scale of the rasterized map, and then applying the proper scale and determined centroid from the parsing and aggregation module 40.

In step 430, when the directional information from the rasterized map is extracted, the feature extraction should be performed in a way that is consistent with the target vector model. That is, feature extraction should be performed in the manner in which the geographic database 20 was established. If the geographic database 20 stores curbs as target vectors, the feature extraction should extract curbs. Likewise, if the geographic database 20 stores street centerlines as target vectors, the feature extraction should extract street centerlines. The most meaningful landmark comparisons between the data sets may be readily automated in this fashion.

To extract and decode the directional information embedded in the rasterized map, the feature extraction module 60 automatically recognizes a directional indicator and infers the rasterized map scale. The feature extraction module 60 identifies and decodes the directional information in the rasterized map, for example by examining the “north” arrow or a compass marker stamp, or the like. In a preferred embodiment, parcel maps are utilized, and the feature extraction module seeks to match features from scanned rasterized maps of variable orientation and scale to a street centerline database. To match the rasterized maps' features to street centerlines from the geographic database 20, the feature extraction module 60 finds and decodes orientation markings by examining the rasterized map and searching for isolated markings in the approximate shape and size of a north arrow, or a “double-north” arrow (jointing to both magnetic north and polar north), or other common orientation marking styles.

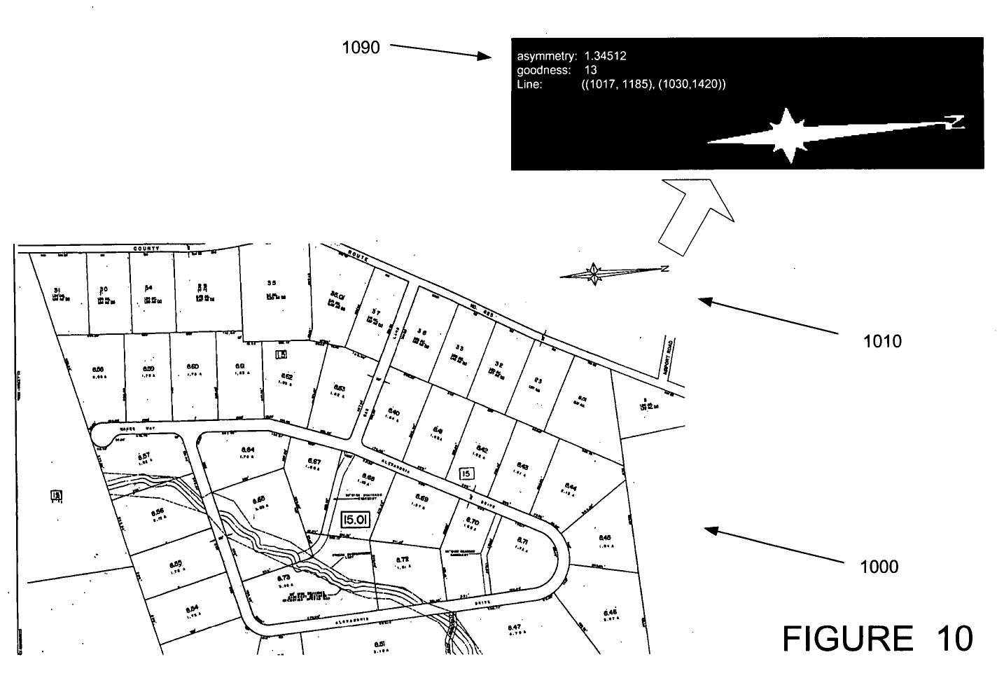

As shown in FIG. 10, the rasterized parcel map is extracted, and the “north arrow” 1010 is examined to determine the rasterized map orientation. The method of the present invention analyzes the “north arrow” 1010, with the analysis information shown in view 1090. Angles are measured and reported using vertical as zero degrees and progressing clockwise. The method of the present invention isolates and identifies the north arrow marking from the parcel map 1000 and determines its direction and goodness. The method identified that, within this north arrow 1010 feature, approximately 13% more of it was pointing downward than pointed in the opposite direction. The larger this polarity value, the stronger the indication that the examined feature is an actual north arrow. This “goodness” value of 13% is sufficient to assure confidence that the examined feature is an actual north arrow, and that it has been correctly parsed. Asymmetry is also measured and evaluated by the method of the present invention and is used to discern true arrows from other line data. The asymmetry for the north arrow 1010 feature under evaluation was a low 1.34512%, indicating a high likelihood that the invention properly identified a true north arrow feature for indicating geographic north. The lower the asymmetry value, the more likely that the examined feature is a true north arrow.

Once a single north arrow marking is isolated, or in the case where several possible north arrow markings remain, the arrow or arrows may be further analyzed to determine their direction. In a preferred embodiment, an operator may select one of two north arrow determination analysis techniques. In the first analysis method, the present invention determines the most distant two-member points of the candidate north arrow marking and records the maximum and minimum distance from an imaginary centerline, connecting the farthest points for every pixel within the candidate marking. This maximum and minimum information is then used to search for acute angles such as are present in directional arrows. The method of the present invention may then select the marking which has the greatest proportion of acute angles, and may further limit the search based on any asymmetry that has been determined during the process. The operator can select angular criteria that express the general shape of such arrows. The angular criteria may then be used as a maximum angular threshold when determining appropriate acute angles.

In the second analysis method, only an arrowhead from the north arrow is retained. This analysis is implemented by analyzing any and all candidate arrowheads at higher order moments in order to determine their direction. The marking with the greatest moment is chosen as the north arrowhead. By using one of the two analysis methods, an accurate determination of the directional component of the rasterized image may be made.

Once the orientation of the map is determined, the feature extraction module 60 infers the scale of the rasterized map. The feature extraction module 60 infers scale by examining long stretches of street, and determining the typical width, knowing the typical ground-truth width of such features. In many parcel maps, the scale is preferably limited to 1:600; 1:1200; 1:2400; 1:4800; and the like. That is, the scale is conventionally of the form 1:(600*2ⁿ). The feature extraction module 60 iterates between scales to determine the best “600-times-two-to-the-n^{th}-power” scale factor to match the perceived “typical” road width found in the rasterized map. The feature extraction module typically examines long stretches of streets, but may evaluate scale based on any large landmark where accurate dimensional data is known. Again, the scale determination is an iterative process where sample vectors are selected and evaluated at a given scale to determine which scale best defines the vector.

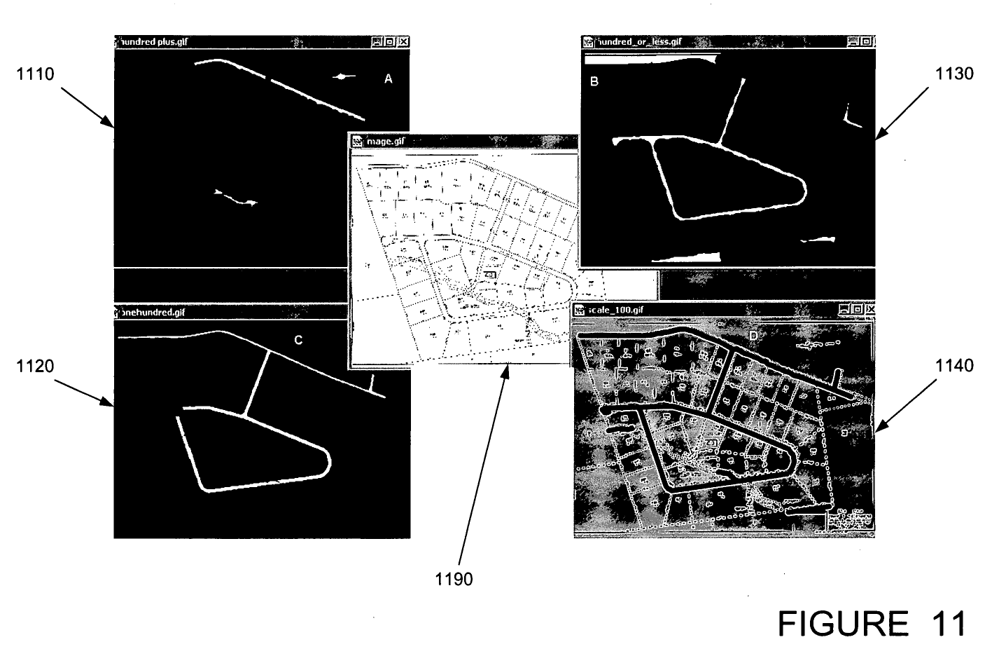

In many cases scale information is inconsistently marked, hand-drawn, or very close to other markings that would produce unreliable results using Optical Character Recognition (OCR) techniques. In such cases, especially since a limited number of scales have been traditionally used in generating maps, the method of the present invention infers the scale by analyzing image features (in this exemplary embodiment, roads) from the rasterized map. Inference involves repeatedly bifurcating the list of possible scales in order to remove one half of the possibilities. As shown in FIG. 11, the example rasterized parcel map comes from a set of maps known to be scaled at one of the following scales: 1″=50′, 1″=100′, 1″=200′, or 1″=400′. The invention focuses or attempts to “narrow down” the scale by performing separate extracts of “likely-road” features at a scale of 1″=200′ or greater, and bifurcating the list of possible scales by performing separate extracts to evaluate those features that are likely to be roads if the scale utilized is 1″=100′ or less. In the example shown in FIG. 11, the image extraction is performed such that streets are extracted at a scale of 1″=200′ or greater and the representative match is shown in 1110. The image extraction is then performed such that streets are extracted at a scale of 1″=100′ or less, and the corresponding match is shown in 1120. The invention compares the quantity of likely matches (e.g., the number of lines that are likely to be streets) in both cases to determine the size of the next scale with which to iterate. In this case, by comparing the representative matches 1110, 1120 to the rasterized parcel map image 1190, it is apparent that using the 1″=100′ scale results in more matches as shown in 1120. That is, the roads are better visualized using the 1″=100′ scale, than when using the 1″=200′ scale as shown in 1110. In this example, the 1″=100′ or less scenario produces better results than the 1″=200′ or more scale, so the invention now attempts to differentiate whether the correct scale is 1″=100′ or 1″=50′. Since there are now only two scale choices remaining, the invention attempts a fast extract at 1″=1100′ as shown in 1130. If the extract results are satisfactory, the 1″=100′ scale will be used; otherwise, the 1″=50′ scale will be used. Since the extracted results of the rasterized image 1190 is satisfactory using the 1″=100′ scale as shown in 1130, the 1″=100′ scale will be used. The final illustration 1140 shows the actual road features extracted by the selection of the 1″=100′ scale. Note that this set of roads is different from the test extract—the final extract performs a more extensive analysis and preferably produces a more comprehensive and accurate result than the test extract shown in 1120. While typical scales have been illustrated in this example shown in FIG. 11, the method of the present invention may perform a scale bifurcation and evaluation using any range of scales.

Once the map scale is determined, in step 440 of FIG. 4, the feature extraction module extracts street centerlines at the determined scale then uses the scale and center-point-referenced-locations to place these centerlines as map vectors in their accurate geographical location. Using the determined scale and known distances of typical landmarks such as curbs or street lanes, the feature extraction module 60 builds a positional correspondence between the two landmark representations (the determined centroid from the parsing and aggregation module 40 and the rasterized image from the rasterized map repository 50) and determines map representation vectors to be used with the target vectors to create the final overlay map.

Step 440 continues as the map representation vectors are extracted at the determined scale by first removing unnecessary annotation. The unnecessary annotations are removed by generally removing small “holes,” unconnected lines, or small-area blocks of dark pixels. Remaining dark pixels may be dilated in order to fill in gaps in line work. Scale extraction then begins by selecting all blank space of a width that is common for features in maps of the selected scale. Such blank space selection may be further narrowed down by considering the length of each blank space, its complexity (measured as the number of skeleton pixels involved in an intersection of leg features, divided by the total number of skeleton pixels), or its overall density (area divided by squared distance of bounding box vertices). The dark pixels remaining after determining the proper blank space and filling in gaps in line work comprise the map representation vectors.

These resulting map representation vectors may be described as the rasterized map data shifted to an accurate position based upon the centroid. The feature extraction module then stores a file describing the reverse transform record, that is, the relationship between the position of the newly-determined map representation vectors in the coordinate space of the target vectors and the position of the features on the original rasterized image. The reverse transform record is typically a set of coefficients to a mathematical equation that can relate the map representation vector positions into image coordinates corresponding to the rasterized map.

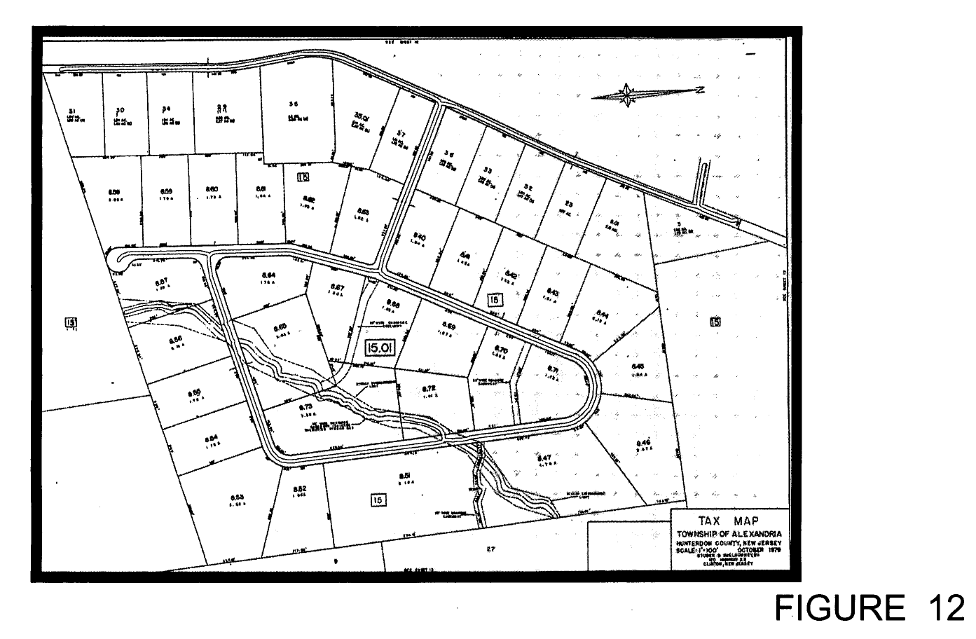

In this manner, the automated feature extraction module 60 makes an accurate representation of the features of the raster map. That is, the representation is true to the rasterized map, yet transformed into the rough coordinate space of the target vectors. The representation is deemed the map representation vectors. An example of the determined map representation vectors for street centerlines is shown in FIG. 12.

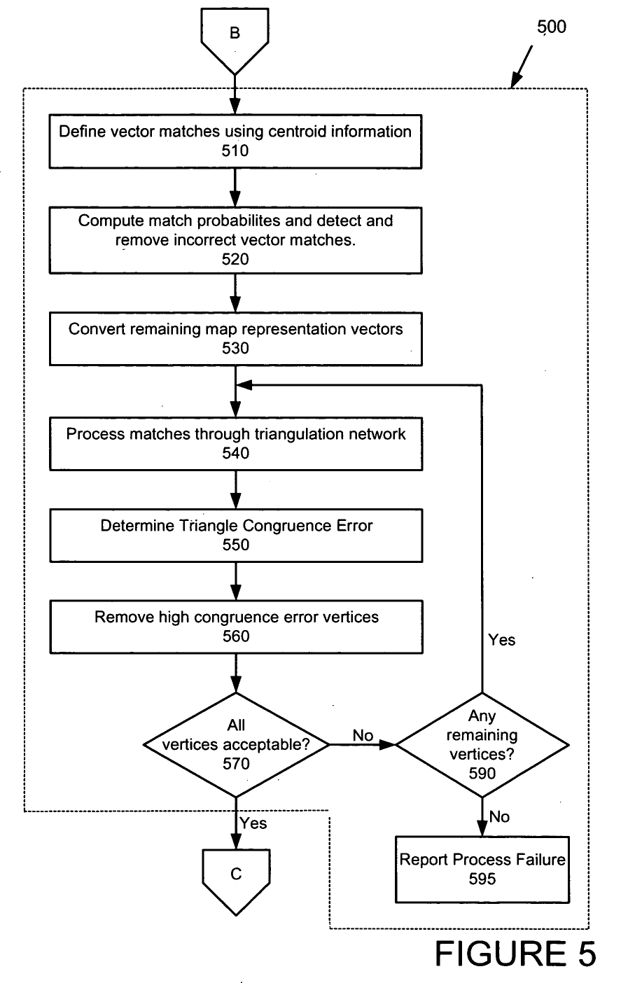

After determining map representation vectors, the method of the present invention continues in FIG. 5. In step 510 of FIG. 5, the conflation module 70 defines matches between the map representation vectors and the target vectors. Conflation is the process of reconciling the positions of corresponding features in the different data sets (map representation vectors and target vectors). Conflation is a process of matching all features in two data sets that represent a common physical feature. The two data sets, that is the target vectors and the map representation vectors, contain the same features, but may not have exactly the same boundaries for that feature. There are many causes for these discrepancies, including digitizing errors and a number of different manipulation and analysis techniques. Features are created on the maps, but when the two data sets (layers) are combined (in an overlay), the layers will not match precisely, and small pieces of the features will not overlap precisely. Conflation techniques are used for removing these small, non-overlapping pieces and reconciling the common boundaries of the displayed features. In the present invention, the extracted map representation vectors are sent to the conflation module 70 where they are compared to target vectors from the geographic database 20. The conflation module 70 then defines matches between the target vectors and the map representation vectors using the centroid reference point and a tunable multivariate stochastic model.

The conflation module 70 begins defining matches by matching nodes. Nodes are the points where two geographic structures intersect, such as two roads, for example. The conflation module 70 iteratively matches the two sets of vectors by choosing the strongest node matches in an early pass, and then conceptually rubber sheeting (correcting flaws by geometrically adjusting coordinates such as by stretching the map surface to align features) and re-matching the two sets of vectors in subsequent iterations until no new matches are found. Node matching uses two match agents. One agent analyzes the candidate nodes' rubber-sheeted offset from each other and area density of nodes. The strength of the match is characterized by a probability function that determines the likelihood of a matched node at the observed distance. The probability function may be based on length ratios, Hausdorff distances, or average distances between boundary sections, or other suitable probability measures. The probability is divided by the node density near the node candidate to determine the accuracy of the assessment. A second agent attempts to build an optimal “test match” of all the feature chains that are incident at the node pair, to determine the similarity of the local features at the nodes.

Following the node matches, the conflation module 70 uses the matched nodes as guides to matching topologic arc chains such as stretches of roads that do not intersect other roads (that is, no nodes). In step 520, match probabilities are computed on the entire Cartesian product of all arc chains, noting all chain pairs whose match probability value exceeds a predetermined threshold. The list of chain pairs is ordered from the strongest matches to the weakest, and each distinct match pair contributes a proportion of its match strength to the node's match strength criteria, and each incident chain not matched in this fashion diminishes the match strength of the node match. Also, matches that fall below a minimum probability may be discarded or manually matched.

In step 530, the remaining map representation vectors with no topological similarities, but with strong match characteristics, are converted and matched. Many match criteria may be established with which to evaluate the matches including overall orientation of the line or shape, convexity, concavity, overall length, neighboring node topology and match status, affine transformation of both lines based on a calculated trend (i.e., translation, rotation, or uniform stretching that carries straight lines into straight lines and parallel lines into parallel lines but may alter distance between points and angles between lines), and the overall quality of those characteristics were the chain to be subdivided for match purposes.

Additionally, attribute-based match agents may be enabled if the associated attributes are available and reliable in both the target vectors and the map representation vectors. These include name, feature classification, lane counts, polygonal boundary coding, and the like.

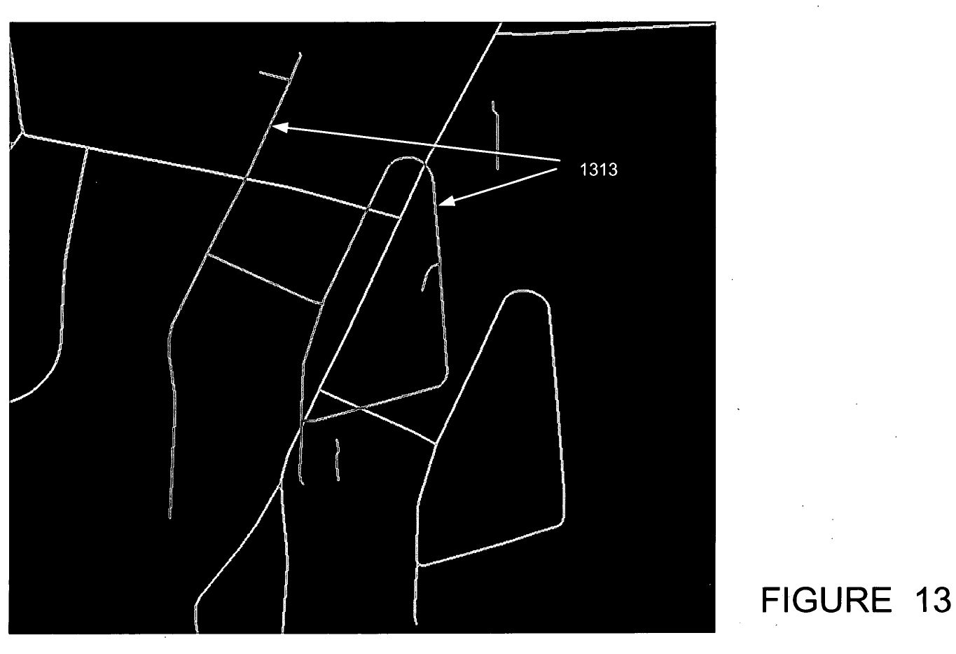

FIG. 13 shows map representation vectors 1313, after the raster centerline was converted in step 530 using the centroid for the map that was determined by the centroid determination subsystem 35. The map image was rotated to the correct north arrow, and the correct scale was selected. The primary source of any remaining error in the image overlay (e.g., the street centerline offset) is due to the inaccuracy of the original centroid used to manipulate the rasterized image.

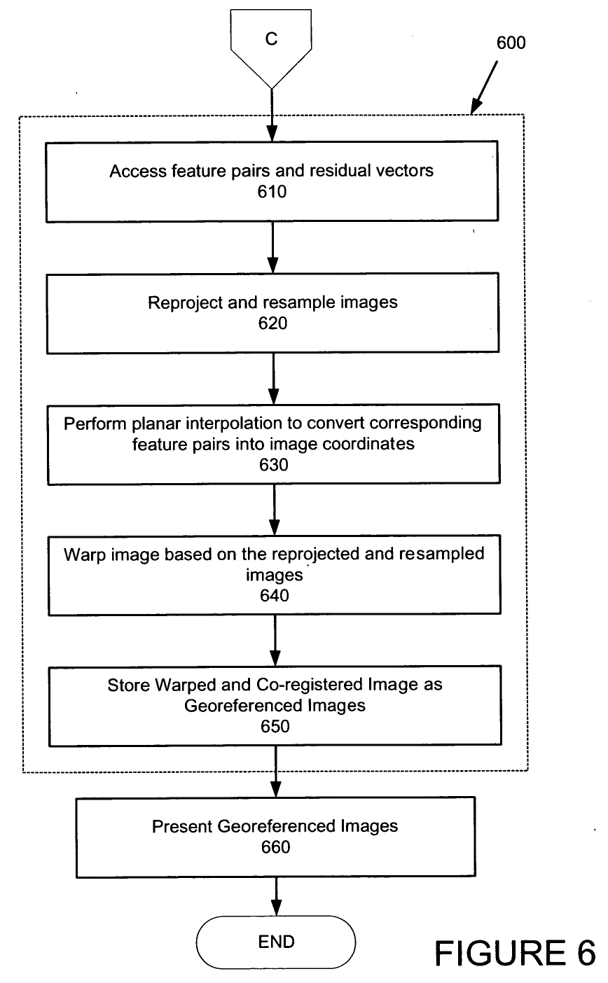

This remaining error may be readily corrected using conflation techniques. Conflation techniques may be used to take advantage of the strong correspondence in shape and orientation of features to match corresponding target vectors and map representation vectors within the same vector space. In step 540, the conflation matches are processed in a Delaunay triangulation network, which is then processed using a quality control algorithm in step 550 that accrues the directional deviation of each source and destination triangle to determine the triangle congruence error. All vertices are assigned the sum of convergence errors in each triangle they bound. All vertices with a congruency error sum above a predetermined threshold are removed in step 560. In step 570, the remaining vertices will be deemed acceptable provided that step 560 had found none in violation of the congruence error threshold. Otherwise, the triangulation interpolation and congruence error check is repeated to ensure that all vertices are acceptable. Upon completion, the acceptable corresponding vectors are passed on to the conversion module 80 (shown in FIG. 6), and if there had been no valid vertices remaining in step 590, an error is reported in step 595.

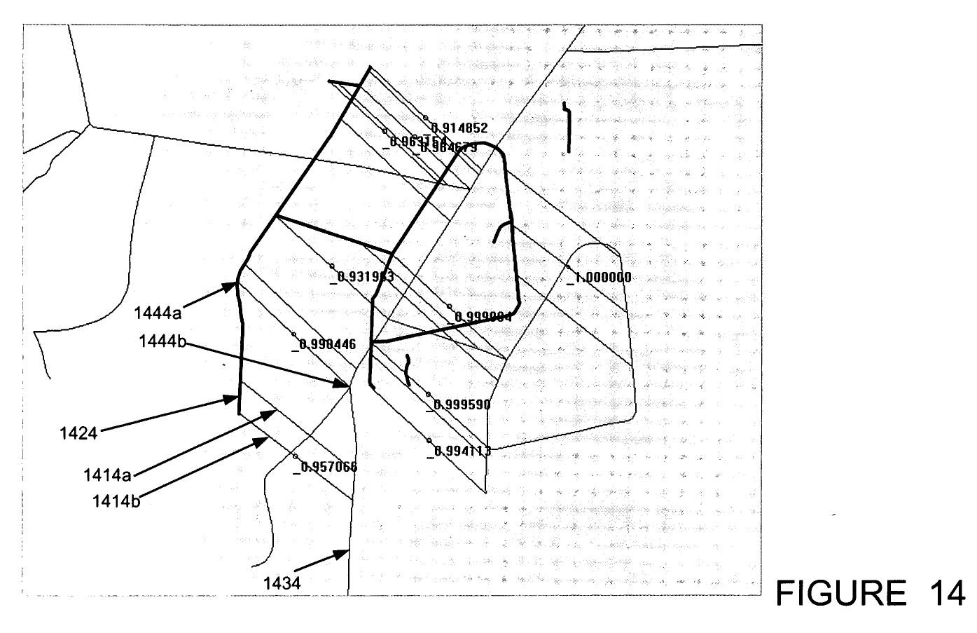

FIG. 14 shows conflation correspondences where correspondence lines 1414a, 1414b match the map representation vectors of the parcel map 1424 and the target vectors 1434 from the geographic image repository. Since the shape and orientation relationship between the roads extracted from the rasterized image and their matching target vectors is strong, conflation techniques recognize high confidence in the matches. This is illustrated in the confidence values shown at various match points 1444a, 1444b of the corresponding vectors, for example, 0.939163 indicates a 93.9163% confidence that the two vectors represent the same physical feature.

Optionally, the unreferenced vectors from step 590 may be further processed before being discarded. To further process the unreferenced vectors, the gross set of vector matches from the conflation module 70 is examined using another interpolation method, such as a bi-linear triangulation, a Voronoi transformation, gridding, or Krieging techniques, or any suitable method of interpolating disparate points. Upon applying this second stage transformation, the resulting fields passed to the conversion module 80 may be a full set of corresponding accurate map vectors.

In this manner, the conflation module 70 correctly detects relationships between the corresponding map representation vectors and the target vectors. Incorrect matches are detected and removed, while the correct matches are converted into offset or “residual” vectors stored as a registration control file to be used later by the conversion module 80. By storing the correct matches as a smaller registration control file rather than as duplicate vectors corresponding to the same physical location, storage space is preserved and access times are improved.

The conversion module registers the target vectors and the map representation vectors to a spatially accurate map sheet. As shown in FIG. 6, the conversion module 80 accesses the feature pairs (residual vectors) from the conflation module 70 in step 610 and co-registers the target vectors and the map representation vectors in a composite (overlay) image based upon the matching performed by the conflation module 70.

In step 620, the invention uses a script to re-project and resample each image based upon the correspondence information regarding the vector sets in the registration control file. The conversion module converts the image into a grid and performs a planar interpolation in step 630 to co-register the map representation vectors and the target vectors feature pairs as grid coordinates.

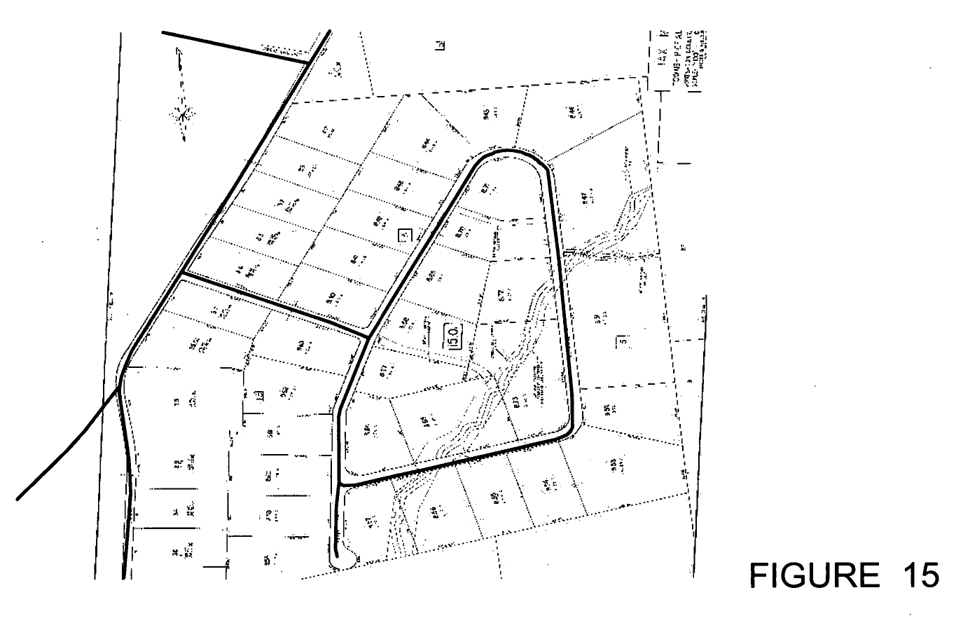

In step 640, the image, including the newly derived grid coordinates, is warped based on the reprojected and resampled images and control files. The control files perform an affine transformation on the grid coordinates in their correct georeferenced location. Upon completion of the affine transformation, the warped grids are converted back to images. FIG. 15 illustrates the completed georeferenced results, where the parcel map is aligned to the coordinates generated by the conflation steps. The resulting parcel map display conforms remarkably well to the target vectors.

Any remaining errors between the two sets of displayed vectors may be addressed in one of two ways. First, the two sets of displayed vectors may be allowed to drift (i.e., not precisely line up). While nearly all of the two sets of vectors are properly matched and displayed, inherent data errors will cause the two sets of vectors to be offset in some small degree at some places in the overlaid image. The integrity of the overlaid image (spatial accuracy, distances, and geographic relationships between landmarks) is maintained, while the overlaid image is not precisely coincident.

The second manner of addressing the data error may eliminate drift error, but requires further warping of the images. The additional warping may eliminate the drift error, but the excessive warping may distort the overlaid image to a great extent, thereby affecting spatial accuracy, distance measurements, and geographic relationships between landmarks. To maintain the accuracy of the overlaid image, in the preferred embodiment, the method of the present invention places a greater emphasis on keeping the image relatively intact rather than precisely matching every curve of the target. Small drift errors are permitted, while errors introduced by excessive warping are not permitted. However, different applications may dictate different conflation matching algorithms. The present invention provides the flexibility to select these customizable techniques based upon the use of a particular map.

The method of the present invention is completed as the warped and co-registered images are then stored as georeferenced images in step 650 and made available for display and further use in step 660.

The devices and subsystems of the exemplary embodiments can communicate, for example, over a communications network, and can include any suitable servers, workstations, personal computers (PCs), laptop computers, PDAs, Internet appliances, set top boxes, modems, handheld devices, telephones, cellular telephones, wireless devices, other devices, and the like, capable of performing the processes of the disclosed exemplary embodiments. The devices and subsystems, for example, can communicate with each other using any suitable protocol and can be implemented using a general-purpose computer system, and the like. One or more interface mechanisms can be employed, for example, including Internet access, telecommunications in any suitable form, such as voice, modem, and the like, wireless communications media, and the like. Accordingly, communications networks employed can include, for example, wireless communications networks, cellular communications networks, satellite communications networks, Public Switched Telephone Networks (PSTNs), Packet Data Networks (PDNs), the Internet, intranets, hybrid communications networks, combinations thereof, and the like. In addition, the communications networks employed can be the same or different networks.

As noted above, it is to be understood that the exemplary embodiments are for representative purposes, as many variations of the specific hardware used to implement the disclosed preferred embodiments are possible. For example, the functionality of the devices and the subsystems of the exemplary systems can be implemented via one or more programmed computer systems or devices. To implement such variations as well as other variations, a single computer system can be programmed to perform the special purpose functions of one or more of the devices and subsystems of the exemplary systems. On the other hand, two or more programmed computer systems or devices can be substituted for any one of the devices and subsystems of the exemplary systems. Accordingly, principles and advantages of distributed processing, such as redundancy, replication, and the like, also can be implemented, as desired, for example, to increase the robustness and performance of the exemplary embodiments.

The exemplary embodiments can be used to store information relating to various processes described herein. This information can be stored in one or more memories, such as a hard disk, optical disk, magneto-optical disk, RAM, and the like, of the devices and sub-systems of the exemplary systems. One or more databases of the devices and subsystems can store the information used to implement the exemplary embodiments. The databases can be organized using data structures, such as records, tables, arrays, fields, graphs, trees, lists, and the like, included in one or more memories, such as the memories listed above.

All or a portion of the exemplary embodiments can be conveniently implemented using one or more general-purpose computer systems, microprocessors, digital signal processors, micro-controllers, and the like, programmed according to the teachings of the disclosed exemplary embodiments. Appropriate software can be readily prepared by programmers of ordinary skill based on the teachings of the disclosed exemplary embodiments. In addition, the exemplary systems can be implemented by the preparation of application-specific integrated circuits or by interconnecting an appropriate network of component circuits.

While the present invention have been described in connection with a number of exemplary embodiments and implementations, the present invention is not so limited but rather covers various modifications and equivalent arrangements, which fall within the purview of the appended claims.

We claim:

1. A method for producing map representation vectors using geographical data, metadata, and raster map data, the method comprising:
determining a centroid of an area of coverage of the raster map data by applying the metadata to the geographical data; and
employing the centroid of the area of coverage of the raster map data to shift the raster map data to determine map representation vectors.

2. The method of claim 1, wherein applying the metadata to the geographical data further comprises standardizing naming of geographical features and producing a comprehensive and accurate depiction of the names of the geographical features.

3. The method of claim 1 wherein the metadata comprises at least one of latitudes, longitudes, master address lists, street edge data, parcel maps, parcel identifiers, block identifiers, map numbers, political boundaries, hydrological boundaries, and topological boundaries.

4. The method for producing map representation vectors of claim 1, wherein employing the centroid of the area of coverage further comprises extracting directional information.

5. The method for producing map representation vectors of claim 4, wherein extracting directional information further comprises decoding orientation markings.

6. The method for producing map representation vectors of claim 5, wherein extracting directional information further comprises inferring map scale.

7. The method for producing map representation vectors of claim 6, wherein extracting directional information further comprises applying the inferred map scale to extract distinct features of the raster map data.

8. A method of reconciling metadata records and target vectors to determine a centroid of an area of interest, the method comprising:
combining the metadata records and the target vectors to form position indexes;
sorting the position indexes; and
evaluating the sorted position indexes against predetermined criteria to determine a centroid of the area of interest.

9. The method of claim 8, wherein the metadata further comprises at least one of latitudes, longitudes, master address lists, street edge data, parcel maps, parcel identifiers, block identifiers, map numbers, political boundaries, hydrological boundaries, and topological boundaries.

10. The method of claim 8, wherein combining the metadata records and the target vectors further comprises forming data supersets of the metadata records and the target vectors.

11. The method of claim 8, wherein sorting the position indexes further comprises creating multiple map sheets if the area of interest is larger than a single overlay map's area of coverage.

12. The method of claim 11, wherein creating multiple map sheets further comprises determining which position index records will appear on each overlay map sheet.

13. The method of claim 12, wherein creating multiple map sheets further comprises determining a centroid of each map sheet.

14. A method of extracting features from raster map data to create map representation vectors, the method comprising:
applying a determined centroid to the raster map data to shift the raster map data to new coordinate positions;
identifying and decoding directional information from the raster map data;
determining a proper scale for the identified and decoded raster map data; and
applying the proper scale and the determined centroid to the identified and decoded raster map data to create map representation vectors.

15. The method of claim 14, wherein the directional information further comprises at least one of the following of a north arrow indicator, a double-north arrow indicator, and a compass marker.

16. The method of claim 15, wherein identifying and decoding directional information further comprises isolating and identifying the directional information by determining the direction, goodness, and asymmetry of the identified directional information.

17. The method of claim 14, wherein determining a proper scale, for the raster map data further comprises examining features of the raster map data at a plurality of selected scales to determine which one of the plurality of selected scales most accurately defines the features of the raster map data.

18. The method of claim 14, wherein applying the proper scale and the determined centroid further comprises placing the features of the raster map data in their proper geographic position by applying the determined scale to features of the raster map data that comprise known distances.

19. A georeferencing system for producing map representation vectors comprising:
a geographic database providing target vectors;
a metadata source module adapted to store metadata corresponding to the target vectors;
a raster map repository adapted to store raster map data;
a centroid determination subsystem for determining a centroid of an area of coverage of the raster map data by applying the metadata to the target vectors; and
a feature extraction module to apply the determined centroid of the area of coverage of the raster map data to shift the raster map data and produce map representation vectors.

20. The georeferencing system of claim 19, wherein the centroid determination subsystem further comprises:
a geocoding module to combine target vectors from the geographic database and metadata from the metadata source module to create position index records;
a parsing and aggregation module to aggregate and sort the position index records and to evaluate the sorted position index records to determine the centroid of the area of coverage of the raster map data.

21. The georeferencing system of claim 20, wherein the geocoding module standardizes data fields to a naming convention.

22. The georeferencing system of claim 19, wherein the feature extraction module extracts directional information.

23. The georeferencing system of claim 22, wherein the feature extraction module extracts directional information by decoding orientation markings.

24. The georeferencing system of claim 23, wherein the feature extraction module infers map scale.

25. The georeferencing system of claim 24, wherein the feature extraction module applies the inferred map scale to extract distinct features of the raster map data.

26. A georeferencing system to reconcile metadata records and target vectors to determine a centroid of an area of interest, the system comprising:
a geographic database adapted to store target vectors;
a metadata source module adapted to store metadata records corresponding to the target vectors; and
a centroid determination subsystem for determining a centroid of an area of interest by applying the metadata records to the target vectors.

27. The georeferencing system of claim 26, wherein the centroid determination subsystem further comprises:
a geocoding module to combine target vectors from the geographic database and metadata records from the metadata source module to create position index records;
a parsing and aggregation module to aggregate and sort the position index records and to evaluate the sorted position index records to determine the centroid of an area of coverage.

28. The georeferencing system of claim 27, wherein the geocoding module standardizes data fields to a naming convention.

29. The georeferencing system of claim 27, wherein the parsing and aggregation module creates multiple map sheets if the area of interest is larger than a single overlay map's area of coverage.

30. The georeferencing system of claim 29, wherein the parsing and aggregation module further determines which position index records will appear on each overlay map sheet.

31. The georeferencing system of claim 30, wherein the parsing and aggregation module further determines a centroid of each map sheet.

32. A georeferencing system to create map representation vectors by extracting features from raster map data, the system comprising:
a raster map repository adapted to store the raster map data;
a feature extraction module adapted to identify and decode directional information from the raster map data, accept an input of a determined centroid, determine a proper scale for the identified and decoded raster map data, and apply the proper scale and the determined centroid to the identified and decoded raster map data to create map representation vectors.

33. The georeferencing system of claim 32, wherein the feature extraction module decodes directional information further comprising at least one of a north arrow indicator, a double-north arrow indicator, and a compass marker.

34. The georeferencing system of claim 33, wherein the feature extraction module further isolates and identifies the directional information by determining the direction, goodness, and asymmetry of the identified directional information.

35. The georeferencing system of claim 32, wherein the feature extraction module determines a proper scale for the raster map data by examining features of the raster map data at a plurality of selected scales to determine one of the plurality of selected scales that most accurately defines the features of the raster map data.

36. The georeferencing system of claim 32, wherein the feature extraction module applies the proper scale and the determined centroid and further places the features of the raster map data in their proper geographic position by applying the determined scale to features of the raster map data that comprise known distances.

37. A data storage medium with computer-executable instructions for producing map representation vectors using geographical data, metadata, and raster map data, the data storage medium comprising:
instructions for determining a centroid of an area of coverage of the raster map data by applying the metadata to the geographical data; and
instructions for employing the centroid of the area of coverage of the raster map data to shift the raster map data to produce map representation vectors.

38. The data storage medium of claim 37, wherein the instruction for applying the metadata to the geographical data further comprise instructions for standardizing naming of geographical features and instructions for producing a comprehensive and accurate depiction of the names of the geographical features.

39. The data storage medium of claim 37, wherein the instructions for applying the metadata further comprise instructions for applying metadata comprising at least one of latitudes, longitudes, master address lists, street edge data, parcel maps, parcel identifiers, block identifiers, map numbers, political boundaries, hydrological boundaries, and topological boundaries.

40. The data storage medium of claim 37, wherein the instructions for employing the centroid of the area of coverage further comprise instructions for extracting directional information.

41. The data storage medium of claim 40, wherein the instructions for extracting directional information further comprise instructions for decoding orientation markings.

42. The data storage medium of claim 41, wherein the instructions for extracting directional information further comprise instructions for inferring map scale.

43. The data storage medium of claim 42, wherein the instructions for extracting directional information further comprise instructions for applying the inferred map scale to extract distinct features of the raster map data.

44. A data storage medium with computer-executable instructions for reconciling metadata records and target vectors to determine a centroid of an area of interest, the data storage medium comprising:
instructions for combining the metadata records and the target vectors to form position index records;
instructions for sorting the position index records; and
instructions for evaluating the sorted position index records against predetermined criteria to determine a centroid of the area of interest.

45. The data storage medium of claim 44, wherein the instructions for combining the metadata records further comprise instructions for combining metadata records comprising at least one of latitudes, longitudes, master address lists, street edge data, parcel maps, parcel identifiers, block identifiers, map numbers, political boundaries, hydrological boundaries, and topological boundaries.

46. The data storage medium of claim 44, wherein the instructions for combining the metadata records and the target vectors further comprise instructions for forming data supersets of the metadata records and the target vectors.

47. The data storage medium of claim 44, wherein the instructions for sorting the position index records further comprise instructions for evaluating multiple map sheets if the area of interest is larger than a single overlay map's area of coverage.

48. The data storage medium of claim 47, wherein the instructions for evaluating further comprise instructions for determining which position index records will appear on each overlay map sheet.

49. The data storage medium of claim 48, wherein the instructions for evaluating further comprise instructions for determining a centroid of each map sheet.

50. A data storage medium with computer-executable instructions for extracting features from raster map data to create map representation vectors, the data storage medium comprising:
instructions for applying a determined centroid to the raster map data to shift the raster map data to new coordinate positions;
instructions for identifying and decoding directional information from the raster map data;
instructions for determining a proper scale for the identified and decoded raster map data; and
instructions for applying the proper scale and the determined centroid to the identified and decoded raster map data to create map representation vectors.

51. The data storage medium of claim 50, wherein the instructions for identifying and decoding directional information further comprise instructions for identifying and decoding directional information comprising at least one of a north arrow indicator, a double-north arrow indicator, and a compass marker.

52. The data storage medium of claim 51, wherein the instructions for identifying and decoding directional information further comprise instructions for isolating and identifying the directional information by determining the direction, goodness, and asymmetry of the identified directional information.

53. The data storage medium of claim 50, wherein the instructions for determining a proper scale for the raster map data further comprise instructions for examining features of the raster map data at a plurality of selected scales to determine which one of the plurality of selected scales most accurately defines the features of the raster map data.

54. The data storage medium of claim 50, wherein the instructions for applying the proper scale and the determined centroid further comprise instructions for placing the features of the raster map data in their proper geographic position by applying the determined scale to features of the raster map data that comprise known distances.

55. A method of producing georeferenced images from disparate data sources comprising the steps of:
recording geographic image data as target vectors in a geographic database;
storing metadata corresponding to the geographic image data in a metadata source module;
associating the metadata and the geographic image data in a geocoding module to create position index records;
parsing and aggregating the position index records to determine a centroid for a map;
registering the centroid in an extraction module;
accessing raster map data from a raster map data repository for use in the extraction module;
extracting directional information from the raster map data to determine map representation vectors based on the centroid and the extracted directional information;
defining data matches between the map representation vectors and the target vectors as corresponding feature pairs;
converting the corresponding feature pairs into an overlay map by iteratively matching nodes and iteratively matching arc chains according to match criteria;
storing the overlay map as a georeferenced image in a georeferenced image repository; and
presenting the georeferenced images as a visual display.

56. The method of claim 55, wherein after associating the metadata and the geographic image data, the method further comprises standardizing naming of geographical features by the geocoding module to produce a comprehensive and accurate depiction of the names of the geographical features.

57. The method of claim 55, wherein the metadata comprises at least one of latitudes, longitudes, master address lists, street edge data, parcel maps, parcel identifiers, block identifiers, map numbers, political boundaries, hydrological boundaries, and topological boundaries.

58. The method of claim 55, wherein extracting directional information further comprises decoding orientation markings.

59. The method of claim 58, wherein the directional information further comprises map scale.

60. The method of claim 58, wherein extracting directional information further comprises applying the inferred map scale to extract distinct features of the raster map data.

61. The method of claim 55, wherein the match criteria in converting the corresponding feature pairs into an overlay map comprises at least one of geospatial criteria, topological criteria, overall orientation, overall curve matching, strong shape matching, and neighborhood node topology.

62. An automated georeferencing system for producing georeferenced images from disparate data sources comprising:
a geographic database recording geographic image data as target vectors;
a metadata source storing metadata records corresponding to the geographic image data;
a centroid determination subsystem to determine a centroid for a map;
a raster map repository storing raster map data for use in a feature extraction module;
a feature extraction module registering the centroid for a map and extracting directional information from the raster map data to determine map representation vectors;
a conflation module to define data matches between the map representation Vectors and the target vectors as corresponding feature pairs;
a conversion module for converting the corresponding feature pairs into images by matching nodes and matching arc chains according to match criteria; and
a georeferenced image storage repository for storing the images as georeferenced images.

63. The automated georeferencing system of claim 62, wherein the centroid determination subsystem further comprises a geocoding module and a parsing and aggregation module wherein the geocoding module associates geographic image data from the geographic database and metadata records from the metadata source to create position index records and wherein the parsing and aggregation module sorts the position index records.

64. The automated georeferencing system of claim 62, wherein the geocoding module further comprises a standardization submodule that standardizes naming of geographical landmarks to produce a comprehensive and accurate depiction of the names of geographical landmarks.

65. The automated georeferencing system of claim 62, wherein the metadata source stores metadata records comprising at least one of the following, latitudes, longitudes, master address lists, street edge data, parcel maps, parcel identifiers, block identifiers, map numbers, political boundaries, hydrological boundaries, and topological boundaries.

66. The automated georeferencing system of claim 62, wherein the feature extraction module extracts directional information comprising orientation markings.

67. The automated georeferencing system of claim 66, wherein the feature extraction module extracts directional information further comprising map scale.

68. The automated georeferencing system of claim 67, wherein the feature extraction module extracts directional information further comprising applying the map scale to extract distinct features of the raster map data.

69. The automated georeferencing system of claim 62, wherein the conflation module defines data matches based upon at least one of geospatial criteria, topological criteria, overall orientation, overall curve matching, strong shape matching, and neighborhood node topology.

70. The automated georeferencing system of claim 62, further comprising an unreferenced vector control module to evaluate unmatched map representation vectors and target vectors and resolve discrepancies between the map representation vectors and the target vectors.

71. A data storage medium with computer-executable instructions for producing georeferenced images from disparate data sources comprising:
instructions for recording geographic image data as target vectors in a geographic database;
instructions for storing metadata records in a metadata source, the metadata records corresponding to the geographic image data;
instructions for a geocoding module to associate geographic image data from the geographic database and metadata from the metadata source to create position index records;
instructions for a parsing and aggregation module to sort the position index records created by the geocoding module to determine a centroid for a map;
instructions for storing raster map data in a raster map repository for use in a feature extraction module;
instructions for registering the centroid for the map in a feature extraction module and for extracting directional information from the raster map data to determine map representation vectors;
instructions for defining data matches between the map representation vectors and the target vectors as corresponding feature pairs;
instructions for converting the corresponding feature pairs into images by matching nodes and matching arc chains according to match criteria; and
instructions for storing the images in a georeferenced image storage repository.

72. The data storage medium of claim 71, wherein the instructions for a geocoding module to associate geographic image data from the geographic database and metadata records from the metadata source module to create position index records further comprise standardization instructions that standardize naming of geographical features to produce a comprehensive and accurate depiction of the names of geographical features.

73. The data storage medium of claim 71, wherein the instructions for storing metadata records corresponding to the target vectors further comprise storing metadata records comprising at least one of latitudes, longitudes, master address lists, street edge data, parcel maps, parcel identifiers, block identifiers, map numbers, political boundaries, hydrological boundaries, and topological boundaries.

74. The data storage medium of claim 71, wherein the instructions for registering the centroid for the map in a feature extraction module and for extracting directional information from the raster map data to determine map representation vectors further comprise instructions for extracting directional information comprising orientation markings.

75. The data storage medium of claim 74, wherein the instructions for registering the centroid for the map in a feature extraction module and for extracting directional information from the raster map data to determine map representation vectors further comprise instructions for extracting directional information comprising map scale.

76. The data storage medium of claim 75, wherein the instructions for registering the centroid for the map in a feature extraction module and for extracting directional information from the raster map data to determine map representation vectors further comprise instructions for extracting directional information comprising applying the map scale to extract distinct features of the raster map data.

77. The data storage medium of claim 71, wherein the instructions for defining data matches between the map representation vectors and the target vectors as corresponding feature pairs further comprise defining data matches based upon at least one of geospatial criteria, topological criteria, overall orientation, overall curve matching, strong shape matching, and neighborhood node topology.

78. The data storage medium of claim 71, wherein the instructions for converting the corresponding feature pairs into images by matching nodes and matching arc chains according to match criteria further comprise instructions for evaluating unmatched map representation vectors and target vectors and resolving discrepancies between the map representation vectors and the target vectors.

79. A method for displaying co-registered data containing target vectors, metadata records, and raster map data, the method comprising:
determining a mapping relationship between the target vectors and the metadata records;
creating position index records from the target vectors and the metadata records;
sorting the position index records to determine a centroid for a map;
linking the centroid for the map to the raster map data;
extracting directional information from the raster map data;
shifting the raster map data based upon the centroid;
creating map representation vectors based on the shifted raster map data and directional information;
matching the map representation vectors and the target vectors;
co-registering the map representation vectors and the target vector by warping a template corresponding to the target vectors;
storing the matches as a composite image in a georeferenced image repository; and
presenting the composite image as a visual display.

80. A method for co-registering images comprising:
selecting a first image having a feature;
selecting metadata corresponding to the feature in the first image;
determining a centroid for a map based upon a correspondence between the first image and the metadata;
selecting raster image data corresponding to the feature in the first image; and
co-registering the first image and the raster image data to incorporate the feature from the first image, the metadata corresponding to the feature, and the raster image data to produce a co-registered image.
